(19) United States
(12) Patent Application Publication
(10) Pub. No.: US 2025/0224551 A1
(43) Pub. Date: Jul. 10, 2025

(54) OPTICAL SYSTEM

(71) Applicant: CANON KABUSHIKI KAISHA, Tokyo (JP)

(72) Inventor: KEIICHIRO ISHIHARA, Saitama (JP)

(21) Appl. No.: 19/090,664

(22) Filed: Mar. 26, 2025

Related U.S. Application Data
(63) Continuation of application No. PCT/JP2023/037880, filed on Oct. 19, 2023.

(30) Foreign Application Priority Data
Oct. 28, 2022 (JP) 2022-173225
Oct. 18, 2023 (JP) 2023-179469

(51) Int. Cl. F21V 8/00; G02B 27/00

(52) U.S. Cl. CPC G02B 6/0035; G02B 6/0025; G02B 6/0088; G02B 27/0081

(57) ABSTRACT

An optical system configured to guide light from a display element to an eyepoint includes a projection unit configured to project the light from the display element, and a light guide configured to guide the light from the projection unit to the eyepoint. The eyepoint is located outside the light guide. The projection unit forms a first pupil. The light guide has a reflector configured to form a second pupil at the eyepoint in a first section parallel to a first direction. A predetermined inequality is satisfied.

### CROSS-REFERENCE TO RELATED APPLICATIONS

This application is a Continuation of International Patent Application No. PCT/JP2023/037880, filed on Oct. 19, 2023, which claims the benefit of Japanese Patent Applications Nos. 2022-173225, filed on Oct. 28, 2022, and 2023-179469, Oct. 18, 2023, each of which is hereby incorporated by reference herein in their entirety.

### BACKGROUND

### Technical Field

The present disclosure relates to an optical system.

### Description of Related Art

An observation optical system has conventionally been known that is used in augmented reality (AR) glasses and has a light guide plate such as a half-mirror lamination type light guide plate or a diffraction type light guide plate. Japanese Patent Laid-Open No. 2017-146447 discloses a light guide for a virtual image display apparatus configured to guide image light from an image display element and emit it to display a virtual image, and a retroreflector (recursive reflector) configured to reverse a traveling direction of image light guided within a light guide member of the light guide. PCT International Publication WO 2020/112836 discloses a display system in which a retroreflector is disposed on the opposite surface of a waveguide layer.

### SUMMARY

An optical system according to one aspect of the disclosure is configured to guide light from a display element to an eyepoint. The optical system includes a projection unit configured to project the light from the display element, and a light guide configured to guide the light from the projection unit to the eyepoint. The eyepoint is located outside the light guide. The projection unit forms a first pupil. The light guide has a reflector configured to form a second pupil at the eyepoint in a first section. The following inequality is satisfied:

$$0 \leq A 1 / f < 0.5$$

where fl is a focal length of the reflector in the first section of the reflector, and A1 is an air-equivalent distance on an optical axis from a reflective surface of the reflector to the first pupil.

An optical system according to another aspect of the disclosure is configured to guide light from a display element to an eyepoint. The optical system includes a projection unit configured to project the light from the display element, and a light guide configured to guide the light from the projection unit to the eyepoint. The eyepoint is located outside the light guide. The projection unit forms a first pupil. The light guide has a reflector configured to form a second pupil at the eyepoint in a first section and a second section orthogonal to the first section.

An optical system according to another aspect of the disclosure is configured to guide light from a display element to an eyepoint. The optical system includes a projection unit configured to project the light from the display element, and a light guide configured to guide the light from the projection unit to the eyepoint. The eyepoint is located outside the light guide. The light guide includes a first reflector configured to deflect the light from the projection unit, two inner surfaces that face each other, and a second reflector that emits the light reflected by the first reflector and the two inner surfaces to outside of the light guide. The first reflector includes a first reflective surface orthogonal to the two inner surfaces. The second reflector includes a plurality of reflective surfaces that are arranged in a direction parallel to the two inner surfaces. The first reflective surface is tilted relative to the direction parallel to the two inner surfaces in a section parallel to the two inner surfaces.

Further features of various embodiments of the disclosure will become apparent from the following description of embodiments with reference to the attached drawings.

### BRIEF DESCRIPTION OF THE DRAWINGS

FIG. 1 is a schematic diagram of a display apparatus in each embodiment.

FIG. 2 explains the function of a light guide plate in each embodiment.

FIG. 3 is a front view of a light guide plate in a first embodiment.

FIG. 4 is a side view of the light guide plate in the first embodiment.

FIGS. 5A and 5B are perspective views of the light guide plate in the first embodiment.

FIGS. 6A and 6B are sectional views of a reconstruction mirror in the first embodiment.

FIGS. 7A, 7B, and 7C are sectional views of a reconstruction mirror according to a first variation of the first embodiment.

FIGS. 8A and 8B are sectional views of a reconstruction mirror according to a second variation of the first embodiment.

FIGS. 9A and 9B are sectional views of a reconstruction mirror according to a third variation of the first embodiment.

FIG. 10 is a sectional view of a reconstruction mirror according to a fourth variation of the first embodiment.

FIG. 11 is a sectional view of a reconstruction mirror according to a fifth variation of the first embodiment.

FIGS. 12A and 12B illustrate the arrangement and configuration of the reconstruction mirror in the first embodiment.

FIGS. 13A and 13B explain a pupil reconstruction mirror unit in a second embodiment.

FIG. 14 is a sectional view of a light guide plate in the second embodiment.

FIG. 15 is a perspective view of a first pupil reconstruction mirror in the second embodiment.

FIG. 16 is a flowchart illustrating a manufacturing method for a light guide plate in a third embodiment.

FIGS. 17A and 17B explain the components of the light guide plate in the third embodiment.

FIG. 18 illustrates pupil reconstruction in the second embodiment.

FIG. 19 explains a light guide plate using a two-dimensional pupil reconstruction mirror according to a variation of the second embodiment.

### DETAILED DESCRIPTION

Referring now to the accompanying drawings, a detailed description will be given of embodiments according to the disclosure. Corresponding elements in respective figures will be designated by the same reference numerals, and a duplicate description thereof will be omitted.

### First Embodiment

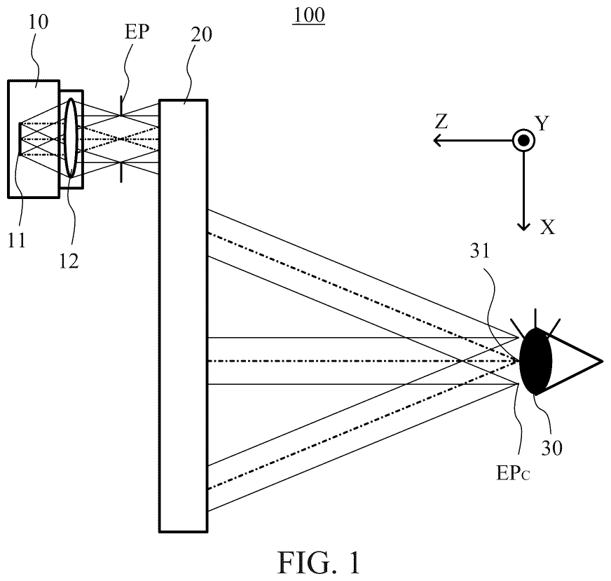

Referring now to FIG. 1, a description will be given of a display apparatus 100 according to this embodiment. FIG. 1 is a schematic diagram of the display apparatus 100. The display apparatus 100 includes a projection unit 10 and a light guide plate (light guide or light guide element) 20. In the following description, the horizontal direction (for example, a direction from the right eye to the left eye of the observer) will be set to an X-axis direction (first direction), the vertical direction will be set to a Y-axis direction (second direction), and a direction orthogonal to the X-axis and Y-axis (a direction from an eyepoint 31 and an observer's eye 30 to the light guide plate 20) will be set to the Z-axis direction. A section including the X-axis and Z-axis will be set to a first section, a section including the Y-axis and Z-axis will be set to a second section, and a section including the X-axis and Y-axis will be set to a third section.

The projection unit 10 includes a display element 11 such as an organic light emitting diode (OLED), and a projection optical system (projection unit) 12. The projection optical system 12 includes a free-form surface prism, and achieves a high acceptance angle and miniaturization. However, this embodiment is not limited to this example, and the projection optical system 12 may use a general optical system instead of the free-form surface prism. The light guide plate 20 is configured to form a second pupil EPc that reconstructs a first pupil (exit pupil) EP of the projection unit 10 (projection optical system 12) at a position of the eyepoint 31 (the pupil of the observer's eye 30) in a one-dimensional direction (for example, in a first section parallel to the first direction). In this embodiment, the projection optical system 12 and the light guide plate 20 configure an optical system (observation optical system) configured to guide light from the display element 11 to the eyepoint 31.

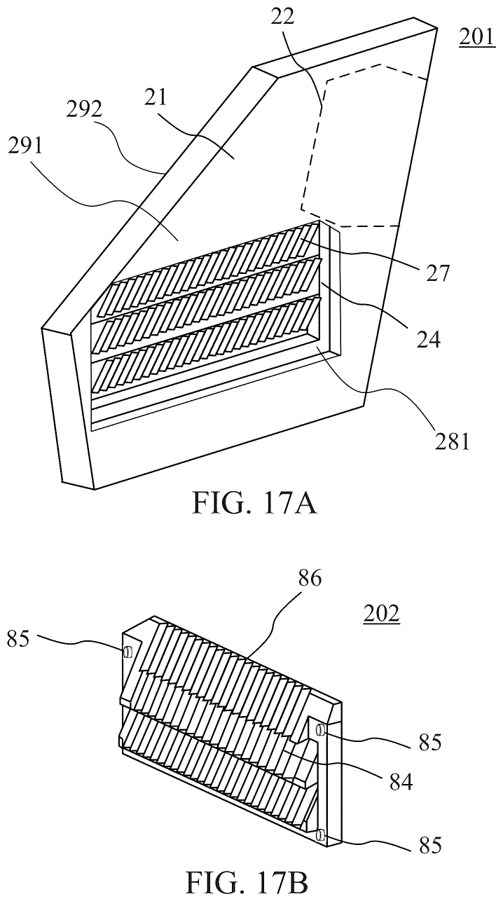

The light beam incident from the projection optical system 12 into the light guide plate 20 has a width equivalent to the thickness of the light guide plate 20 in the thickness direction of the light guide plate 20, and has a light beam width narrower than the width of the light guide plate 20 in the width direction of the light guide plate. Such a light beam travels while being reflected by the internal surfaces within the light guide plate 20 (two light guide substrates (e.g., planar substrates 291 and 292 in FIG. 17A) that hold the pupil reconstruction mirror 24). Of the light beams emitted from the light guide plate, the light beam in the width direction of the light guide plate is responsible for the light beam in the first section (horizontal section), and the light beam in the thickness direction of the light guide plate is responsible for the light beam in the second section (vertical section).

In this embodiment, the ratio of the angle of view in the horizontal section (X-axis section) and the vertical section (Y-axis section) of the display apparatus 100 is 16:9. Since the second pupil EPc may be formed at least in the direction with the wider angle of view in order to improve the light utilization efficiency, the light guide plate 20 forms the second pupil EPc by reconstructing the first pupil (exit pupil) EP in the horizontal section. However, this embodiment is not limited to this example, and the second pupil EPc may be formed in the vertical section (Y-axis section) instead of in the horizontal section.

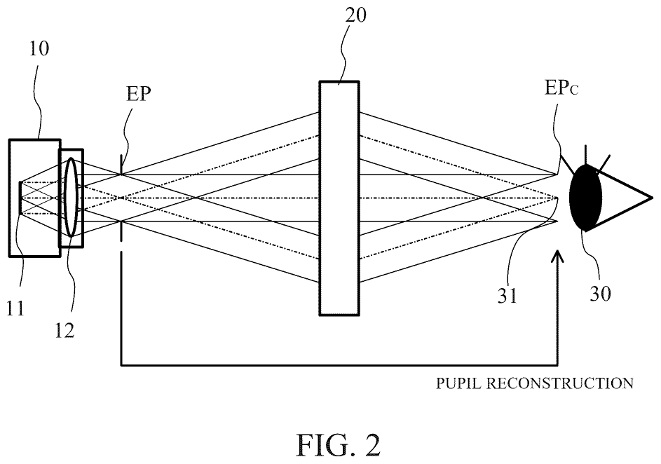

Referring now to FIG. 2, a description will be given of a function of the light guide plate 20. FIG. 2 explains the function of the light guide plate 20. The light guide plate 20 is a pupil reconstruction light guide plate that forms a second pupil EPc by reconstructing the first pupil (exit pupil) EP of the projection unit 10 (projection optical system 12) at the eyepoint 31 where the observer's eye 30 is located. In this embodiment, the state in which the second pupil EPc similar to the first pupil (exit pupil) EP of the projection unit 10 is reconstructed at the position of the eyepoint 31 will be sometimes called “pupil reconstruction.” This indicates a state in which the angle-of-view light beams emitted from the first pupil and diffused are gathered again and overlapped, rather than forming a second pupil as a conjugate image formed by imaging the first pupil. Since the angle-of-view light beams are not affected by imaging and have no power, the light emitted as a parallel light beam from the first pupil is condensed on the second pupil as a parallel light beam.

The light guide plate 20 has a pupil reconstruction mirror (reflector) 24, and forms a second pupil EPc at the eyepoint 31 by reconstructing the first pupil EP of the projection unit 10 in a one-dimensional direction (within the first section, or in a second section orthogonal to the first section, in the horizontal or vertical direction). The reflective surface of the pupil reconstruction mirror 24 is tilted relative to the surface of the light guide substrate in the second section, and the light reflected by the pupil reconstruction mirror 24 passes through the light guide substrate and is emitted to the outside of the light guide plate 20. The pupil reconstruction mirror 24 includes a plurality of reflective surfaces arranged in a second direction orthogonal to the first direction, and angles formed by the plurality of reflective surfaces and the surface of the light guide substrate are equal to each other.

The observer places his eye 30 at the eyepoint 31. Thereby, wasted light that does not enter the observer's eye 30 can be reduced, and thus the proportion of light that reaches the observer's eye 30 out of the light projected from the projection unit 10 (the light utilization efficiency of the light guide plate 20) can be increased. The location where the second pupil EPc is formed is the position of the eyepoint 31, but the effect of this embodiment can be sufficiently obtained as long as it is located near the eyepoint 31 to some extent.

The pupil reconstruction mirror 24 having a pupil reconstruction function in a one-dimensional direction (first direction, horizontal direction) may have the following configuration. That is, in a direction in which the pupil reconstruction mirror 24 does not have the pupil reconstruction function (second direction, vertical direction), a configuration may be used in which light enters the pupil reconstruction mirror 24 at an angle other than a vertical angle and is reflected in a direction different from the incident direction. Thereby, the second pupil EPc can be disposed in a location different from the first pupil EP, and thus the second pupil can be formed at an eyepoint outside the light guide element.

The pupil reconstruction mirror (mirror) 24 in this embodiment reconstructs a new pupil while keeping the light beam approximately parallel by reflecting it twice on the pupil reconstruction mirror. Here, the optical system according to this embodiment may satisfy the following inequality (1).

$$0. \leq A 1 / f < 0.5 \qquad ( 1 )$$

where f (mm) is a focal length of the pupil reconstruction mirror 24 in the first section and A1 (mm) is an air-equivalent distance on the optical axis from the reflective surface (for example, the center of the reflective surface) of the pupil reconstruction mirror 24 to the first pupil EP.

Here, the optical axis corresponds to the optical path of the principal ray projected onto the YZ section, and the air-equivalent distance corresponds to the actual distance (for A1, the optical path length of the principal ray when projected onto the section)/refractive index of the light guide element.

Inequality (1) means that the focal length of the pupil reconstruction mirror 24 is longer than twice the optical path length (A1), and the power (refractive power) of the pupil reconstruction mirror 24 is sufficiently small.

In the light guide element, the optical element is divided into a plurality of elements to reduce the plate thickness of the light guide element. In a case where the optical element that reconstructs the pupil is divided into a plurality of elements, a distance from the first pupil to each optical element is different. In this situation, in a case where the light guide element uses its refractive power to form a conjugate pupil, the problem of the convergence degree of the light beam that differs for each divided optical element occurs because the distance from the first pupil to each optical element is different. In a case where the refractive power is changed for each divided optical element, the convergence degree of the light beam can be uniform, but the angle of view is expanded or contracted for each divided optical element, and a shift in the angle of view occurs. In contrast, by setting the refractive power of the pupil reconstruction mirror to satisfy inequality (1), the light beam can be directed as an approximately parallel light beam to the second pupil without changing the convergence degree of the light beam and without changing the angle of view, even if the pupil reconstruction mirror includes a plurality of optical elements.

Inequality (1) may be replaced with inequality (1a) below:

$$0. \leq A 1 / f < 0.3 \qquad ( 1 a )$$

Inequality (1) may be replaced with inequality (1b) below. Inequality (1b) means that the refractive power of the pupil reconstruction mirror 24 is zero (no refractive power). In this embodiment, the pupil reconstruction mirror 24 having no refractive power can reconstruct the pupil while the incident light is maintained as a parallel light beam, and better optical performance can be achieved.

$$A / f = 0.0 \qquad ( 1 b )$$

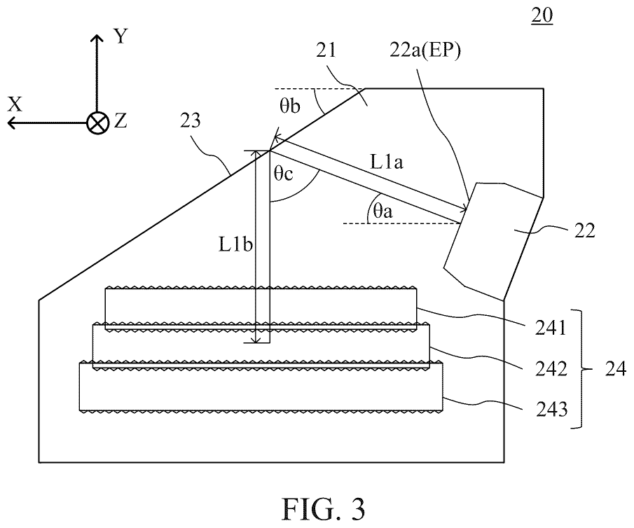

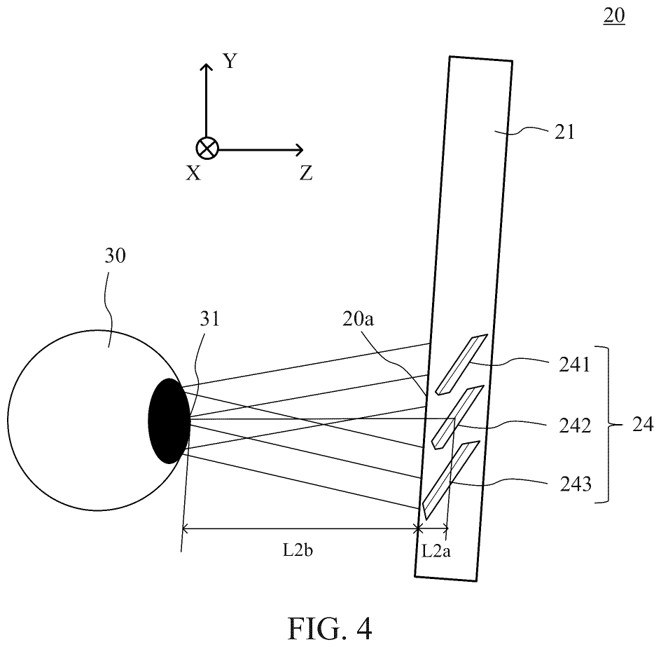

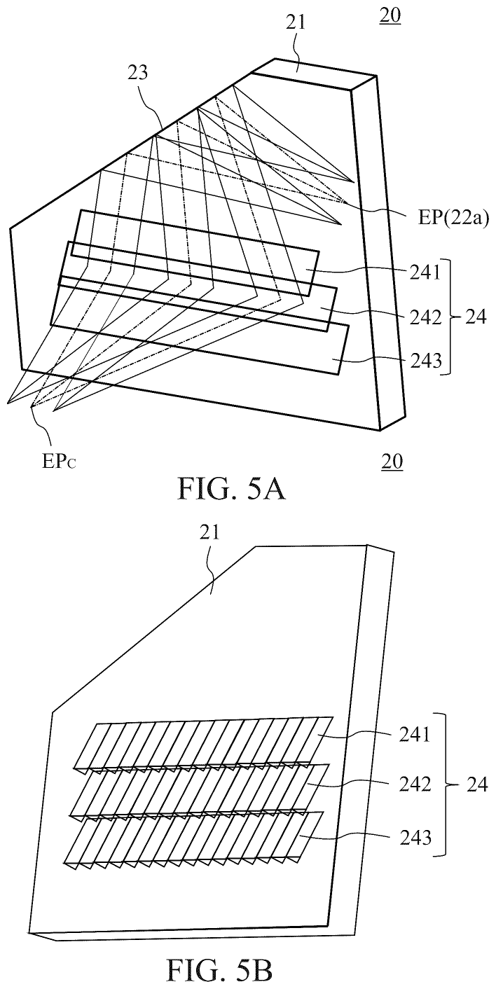

Referring now to FIGS. 3 to 5B, a description will be given of a configuration of the light guide plate 20. FIG. 3 is a front view of the light guide plate 20. FIG. 4 is a side view of the light guide plate 20. FIGS. 5A and 5B are perspective views of the light guide plate 20. As illustrated in FIGS. 3 and 4, the light guide plate 20 includes a light guide substrate 21, a head (entrance portion) 22, a bending mirror (first reflector) 23, and a pupil reconstruction mirror (extraction mirror) 24.

The bending mirror 23 is a first reflector configured to deflect light from the projection optical system 12. The pupil reconstruction mirror 24 is a second reflector that emits light reflected by two inner surfaces facing each other, a first reflective surface, and the two inner surfaces to the outside of the light guide plate 20. The first reflector includes the first reflective surface orthogonal to the two inner surfaces, and the second reflector includes a plurality of reflective surfaces arranged in a direction parallel to the two inner surfaces, and the first reflective surface is tilted relative to the direction parallel to the two inner surfaces in a section parallel to the two inner surfaces.

The pupil reconstruction mirror 24 includes a first retroreflective (retroreflecting or recursive) mirror 241, a second retroreflection mirror 242, and a third retroreflection mirror 243. In order to reduce the thickness of the light guide plate 20, three retroreflection mirrors 241, 242, and 243 are arranged, and each of the retroreflection mirrors 241, 242, and 243 forms a second pupil that reconstructs the first pupil EP. However, this embodiment is not limited to this example, and the number of retroreflection mirrors that constitute the pupil reconstruction mirror 24 may be other than three.

As illustrated in FIGS. 3 and 5A, the first pupil (exit pupil) EP of the projection optical system 12 is formed inside the light guide plate 20 (at the position of a root (tip) 22a of the head 22). Light from the projection optical system 12 is guided toward the bending mirror 23, reflected by the bending mirror 23, and reflected by the pupil reconstruction mirror 24. As a result, a light beam is emitted to the outside of the light guide plate 20.

The observation optical system according to this embodiment bends a light path in the light guide plate using the bending mirror 23, and an angle between the light path before and after the bending mirror 23 is set to an acute angle of θc=69°. Thereby, the height (distance) of the light guide plate in the vertical direction (Y-axis direction) can be reduced. The angle of the light path from the first pupil (exit pupil) EP of the projection optical system to the bending mirror 23 is set to θa=21°, and light is guided at an angle upward from the horizontal direction (θa=0°). Thereby, the tilt angle of the bending mirror 23 is set to θb=34°, which is closer to the horizontal direction than 45°, and the height of the terminal end of the bending mirror 23 is reduced.

The observation optical system according to this embodiment can form a second pupil EPc, which is made by reconstructing the first pupil (exit pupil) EP of the projection unit 10 in the horizontal direction at the position of the eyepoint 31 outside the light guide plate 20. As illustrated in FIG. 5B, each of the three retroreflection mirrors 241, 242, and 243 is a right-angle mirror array in which a plurality of right-angle mirrors are arranged along a first direction (horizontal direction in the local coordinate system of the retroreflection mirrors) in which an angle formed by the two reflective surfaces in the first direction is a right angle. In this embodiment, the three retroreflection mirrors 241, 242, and 243 are arranged along the vertical direction (first direction). That is, the pupil reconstruction mirror 24 includes a plurality of right-angle mirrors each having two reflective surfaces that form a right angle in the first section, and the plurality of right-angle mirrors are arranged along the first direction.

Now assume that A1 (mm) is an air-equivalent distance from the reflective surface of the pupil reconstruction mirror 24 to the first pupil (exit pupil) EP (root 22a of the head 22) of the projection unit 10, and A2 (mm) is an air-equivalent distance on the optical axis from the reflective surface of the pupil reconstruction mirror 24 to the eyepoint (pupil) 31. The eyepoint 31 is the position where the second pupil EPc is formed, and corresponds to the position of the observer's eye 30 in this embodiment. The eyepoint 31 is located, for example, at a distance of about 12 mm to 18 mm from the exit surface of the light guide plate 20 (while the eye relief is 12 mm to 18 mm), but is not limited to this example and varies according to the size of the display apparatus and whether it is compatible with vision correction glasses.

As illustrated in FIG. 3, assume that L1a is a distance from the position of the root 22a of the head 22 to the position of the bending mirror 23 within the light guide substrate 21. L1b is a distance from the position of the bending mirror 23 in the light guide substrate 21 to the position of the pupil reconstruction mirror 24 (which corresponds to the center of the second retroreflection mirror 242 in this embodiment, the height position of the observer's eye 30, or the position where the principal ray at the center of the angle of view reaches the pupil reconstruction mirror 24). N is a refractive index of the light guide substrate 21 for the d-line. In this case, the air-equivalent distance A1 is expressed as follows:

$$A 1 = ( L 1 a / N ) + ( L 1 b / N )$$

As illustrated in FIG. 4, L2a is a distance from the position of the pupil reconstruction mirror 24 in the light guide substrate 21 (which corresponds to the center position of the pupil reconstruction mirror 24 in the thickness direction of the light guide plate 20 or the center position of the second retroreflection mirror 242 in this embodiment) to the position of the exit surface 20a of the light guide plate 20. L2b is a distance from the exit surface 20a of the light guide plate 20 to the eyepoint 31 in air. In this case, the air-equivalent distance A2 is expressed as follows:

$$A 2 = ( L 2 a / N ) + L 2 b$$

In this embodiment, to reconstruct the first pupil (exit pupil) EP of the projection optical system 12 at the position of the eyepoint 31 (to achieve the pupil reconstruction), the relationship between the air-equivalent distances A1 and A2 may satisfy the following inequality (2):

$$0.5 < A 2 / A 1 < 2.0 \qquad ( 2 )$$

In a case where A2/A1 becomes higher than the upper limit of inequality (2), the pupil is formed in front of the observer's eye 30, and the observer cannot view the image at a wide angle of view (a simultaneous observable angle of view becomes narrower). In a case where A2/A1 becomes lower than the lower limit of inequality (2), the pupil is formed behind the observer's eye 30, and the observer cannot view the image at a wide angle of view (a simultaneous observable angle of view becomes narrower). Regarding the distance L1b, in a case where a plurality of retroreflection mirrors are provided, inequality (2) may be satisfied for the distance L1b to all (three in this embodiment) of the retroreflection mirrors (for example, the distance to the center of the first retroreflection mirror 241).

Inequality (2) may be replaced with inequality (2a) below:

$$0.6 < A 2 / A 1 < 1.5 \qquad ( 2 a )$$

Inequality (2) may be replaced with inequality (2b) below:

$$0.8 < A 2 / A 1 < 1.2 \qquad ( 2 b )$$

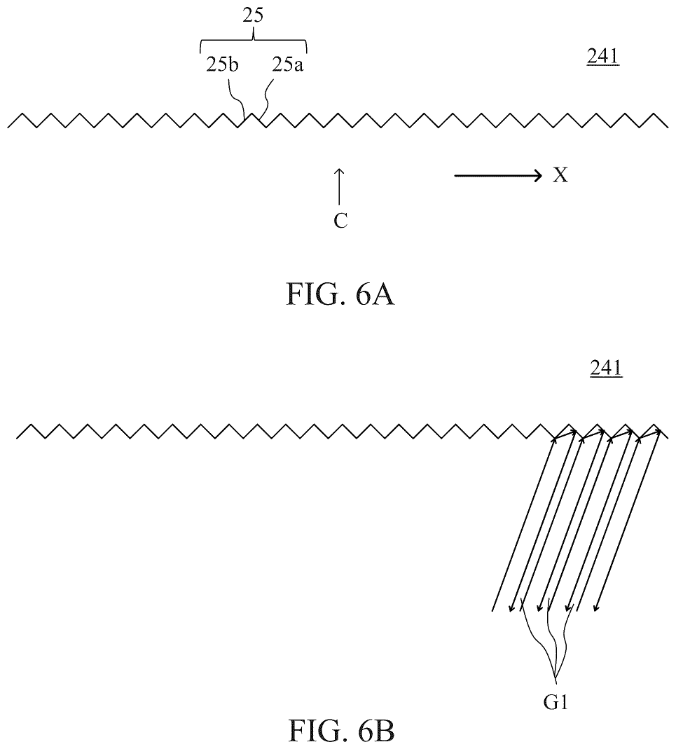

Referring now to FIGS. 6A and 6B, a description will be given of the configuration of the pupil reconstruction mirror 24 in this embodiment. FIGS. 6A and 6B are sectional views of the retroreflection mirror 241 that constitutes the pupil reconstruction mirror. As illustrated in FIG. 6A, the retroreflection mirror 241 is configured by arranging a plurality of right-angle mirrors 25 in the X-axis direction (horizontal direction) in the local coordinates of the retroreflection mirror. That is, in a section (first section) along the horizontal direction (X-axis direction), the heights (distances) from the bottom peaks (valleys) to the top peaks (mountains) of the plurality of right-angle mirrors 25 are equal (constant in the horizontal direction).

Each of the plurality of right-angle mirrors 25 includes a first mirror 25a and a second mirror 25b arranged orthogonal to each other. The first mirror 25a constitutes an inner surface (surface closer to the central portion C) of the right-angle mirror 25. The second mirror 25b constitutes an outer surface (surface farther from the central portion C) of the right-angle mirror 25.

According to the retroreflection mirror 241 illustrated in FIG. 6B, in the horizontal section, light incident on the right-angle mirror 25 is reflected by the second mirror 25b and the first mirror 25a, and is reflected in the same direction as that of the incident light. In this way, the light reflected by the right-angle mirror 25 has a retroreflecting property that returns to the original direction.

The right-angle mirror 25 has no refractive power because it includes two plane mirrors. Therefore, the right-angle mirror 25 can reflect a parallel light beam incident on the right-angle mirror 25 as a parallel light beam. The retroreflection mirror 241, which includes a plurality of right-angle mirrors 25, can reconstruct the second pupil by reflecting the light beam emitted from the exit pupil of the projection optical system (not illustrated). Thus, the retroreflection mirror 241 can function as the pupil reconstruction mirror 24.

The pupil reconstruction mirror using the right-angle mirror array has no refractive power, so even if it is divided in the vertical direction, it can reconstruct the pupil without changing the convergence degree or angle of view of the light beam at each retroreflection mirror.

The retroreflection mirror 241 illustrated in FIG. 6B can achieve pupil reconstruction in the horizontal direction, but a large gap G1 occurs between the light beams reflected from the retroreflection mirror 241. As a result, the gap G1 between the light beams is reflected as shading in the displayed image, which may result in artifacts.

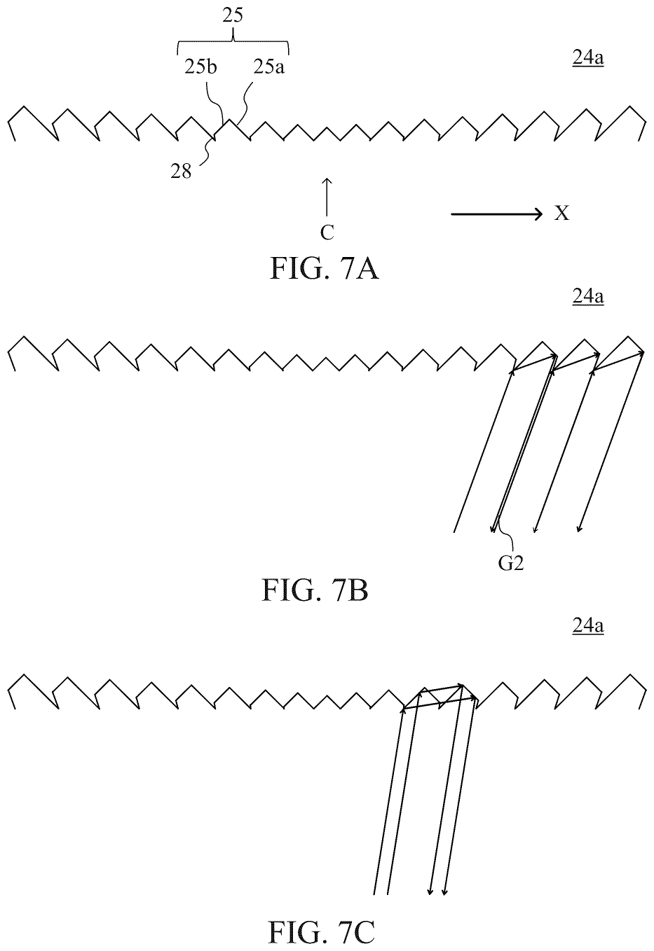

Referring now to FIGS. 7A to 7C, a description will be given of the configuration of the pupil reconstruction mirror 24a according to a first variation of this embodiment. FIGS. 7A to 7C are sectional views of the pupil reconstruction mirror 24a. As illustrated in FIG. 7A, the pupil reconstruction mirror 24a is configured such that, of the two surfaces of the two right-angle mirrors 25, the inner surface (first mirror 25a) is wider than the outer surface (second mirror 25b). The root portion of the outer surface is cut, and the cut surface 28 is formed to be parallel to the reflected light. The pupil reconstruction mirror 24a is configured such that the right-angle mirror 25 becomes higher as the position approaches the peripheral portion (outside) from the central portion C (inside).

In other words, in this variation, the first mirror 25a is wider than the second mirror 25b in a section along the horizontal direction in at least one of the plurality of right-angle mirrors 25. At least one of the second mirrors 25b has the cut surface 28 cut at an angle different from that of the mirror surface. The height (distance) from the bottom peak (valley) to the top peak (mountain) of each of the plurality of right-angle mirrors 25 becomes higher (longer) as the position approaches the peripheral portion from the central portion C of the pupil reconstruction mirror 24.

Due to this configuration, as illustrated in FIG. 7B, a gap G2 of the light beam reflected by the pupil reconstruction mirror 24a can be smaller than the gap G1 of the light beam reflected by the pupil reconstruction mirror 24. The cut surface 28 of the outer surface (second mirror 25b) of the right-angle mirror 25 parallel to the reflected light can minimize the gap G2. As illustrated in FIG. 7C, the pupil reconstruction mirror 24a is configured so that the light beam reflected by one surface (inner surface) of the right-angle mirror 25 passes through the other surface (outer surface), passes through one surface (inner surface) of the adjacent right-angle mirror 25, and is reflected by the other surface (outer surface). Thereby, the light utilization efficiency can be increased, for example, by about 10%. The pupil reconstruction mirror 24a is formed so that the right-angle mirror 25 becomes higher as the position approaches the outside (peripheral portion) from the inside (central portion C), so even if the light reflected to the outside travels obliquely, an amount reflected by the right-angle mirror 25 again increases.

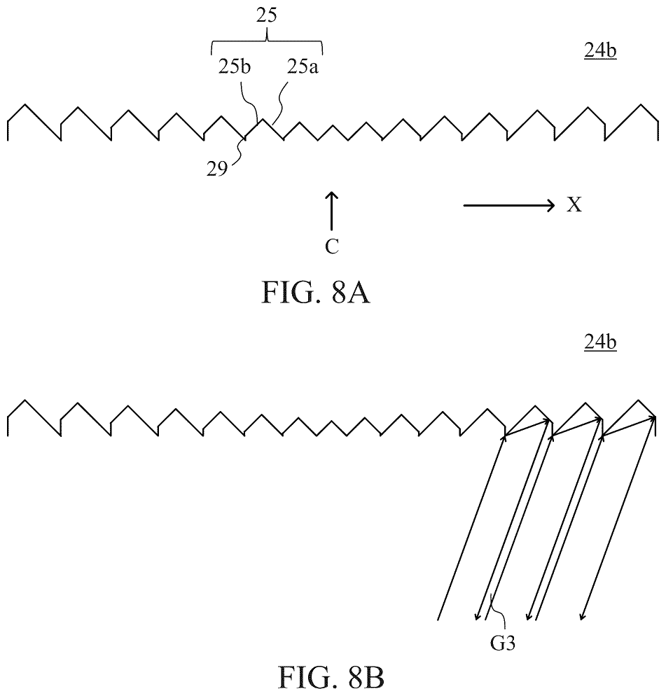

Referring now to FIGS. 8A and 8B, the configuration of a pupil reconstruction mirror 24b according to a second variation of this embodiment will be described. FIGS. 8A and 8B are sectional views of the pupil reconstruction mirror 24b. As illustrated in FIG. 8A, the pupil reconstruction mirror 24b is configured so that, of the two surfaces of the two right-angle mirrors 25, the inner surface (first mirror 25a) is wider than the outer surface (second mirror 25b). The root of the outer surface is cut, and the cut surface 29 is disposed orthogonal to the arrangement direction (horizontal direction) of the right-angle mirrors 25 (the normal direction of the cut surface 29 is parallel to the arrangement direction of the right-angle mirrors 25). The pupil reconstruction mirror 24b is configured so that the right-angle mirror 25 becomes higher as the position approaches the peripheral portion (outside) from the central portion C (inside).

Due to this configuration, as illustrated in FIG. 8B, a gap G3 of the light beam reflected by the pupil reconstruction mirror 24b becomes smaller than the gap G1 of the light beam reflected by the pupil reconstruction mirror 24. The gap G3 of the light beam reflected by the pupil reconstruction mirror 24b is slightly larger than the gap G2 of the light beam reflected by the pupil reconstruction mirror 24a, but the molding process of the pupil reconstruction mirror 24b is easier than that of the pupil reconstruction mirror 24a during molding.

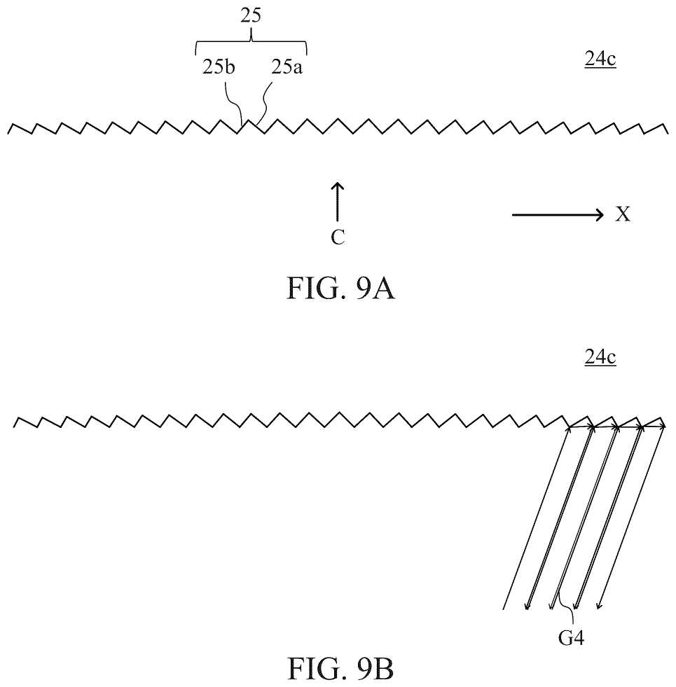

Referring now to FIGS. 9A and 9B, the configuration of a pupil reconstruction mirror 24c according to a third variation of this embodiment will be described. FIGS. 9A and 9B are sectional views of the pupil reconstruction mirror 24c. In this variation, in a section along the horizontal direction, rotation angles of the two right-angle mirrors 25 of the pupil reconstruction mirror 24c increase (their angles rotate inward) as the position approaches the peripheral portion from the central portion C. That is, as illustrated in FIG. 9A, the angles of the plurality of right-angle mirrors 25 vary according to the distance from the central portion C of the pupil reconstruction mirror 24c. The central portion may be disposed at a position shifted from the width center of the pupil reconstruction mirror 24c. The angle of each right-angle mirror 25 may be configured so that a light ray parallel to the principal ray of the angle-of-view light beam reaching each right-angle mirror 25 enters the end of the first mirror 25a, is reflected, enters the end of the second mirror 25b, and is reflected. An angle error of each right-angle mirror may be 5° or less. Due to this configuration, a gap G4 of the light beam reflected by the pupil reconstruction mirror 24c illustrated in FIG. 9B can be smaller than the gap G1 of the light beam reflected by the pupil reconstruction mirror 24 illustrated in FIG. 6B.

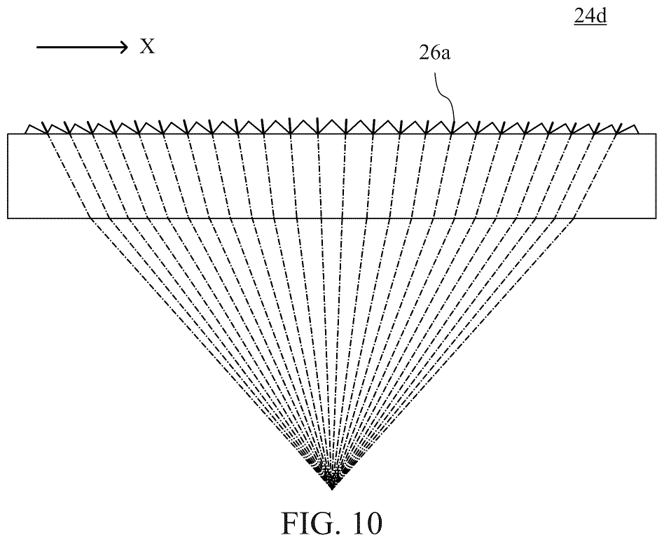

Referring now to FIG. 10, a description will be given of the configuration of a pupil reconstruction mirror 24d according to a fourth variation of this embodiment. FIG. 10 is a sectional view of the pupil reconstruction mirror 24d. As illustrated in FIG. 10, the pupil reconstruction mirror 24d includes, in addition to the configuration of the pupil reconstruction mirror 24c, a light shielding member 26a disposed between adjacent right-angle mirrors (at the bottom peak of each right-angle mirror) so as to extend to the top peak of each right-angle mirror. Each of the plurality of light shielding members 26a is disposed parallel to the angle-of-view light beam (so that the normal direction of the surface of the light shielding member 26a moves away from the arrangement direction (horizontal direction) of the right-angle mirrors as the position approaches the peripheral portion from the central portion C).

In the pupil reconstruction mirror 24c in which the angle of each right-angle mirror changes, the display light that transmits and is reflected by the adjacent orthogonal mirror may become ghost light. However, the configuration according to this variation can reduce the ghost by cutting (shielding) the light from the adjacent right-angle mirror. In a case where see-through light reflected by the pupil reconstruction mirror 24d heads toward the observer's eye 30, it becomes ghost light. Therefore, this variation can reduce the ghost by cutting the reflected light of the optical see-through light.

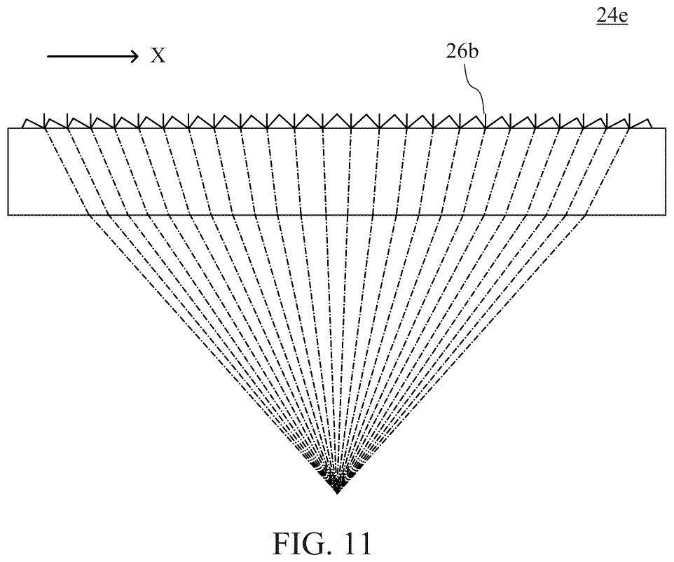

Next, referring to FIG. 11, the configuration of a pupil reconstruction mirror 24e according to a fifth variation of this embodiment will be described. FIG. 11 is a sectional view of the pupil reconstruction mirror 24e. As illustrated in FIG. 11, in addition to the configuration of the pupil reconstruction mirror 24c, the pupil reconstruction mirror 24e has a light shielding member 26b disposed between adjacent right-angle mirrors (at the bottom peak of each right-angle mirror) so as to extend to the top peak of each right-angle mirror. The plurality of light shielding members 26b are arranged so that the normal direction of the surface of the light shielding member 26b is parallel to the arrangement direction (horizontal direction) of the right-angle mirrors. Therefore, according to this variation, compared to the pupil reconstruction mirror 24d having the light shielding members 26a, manufacturing by metal molding is easier.

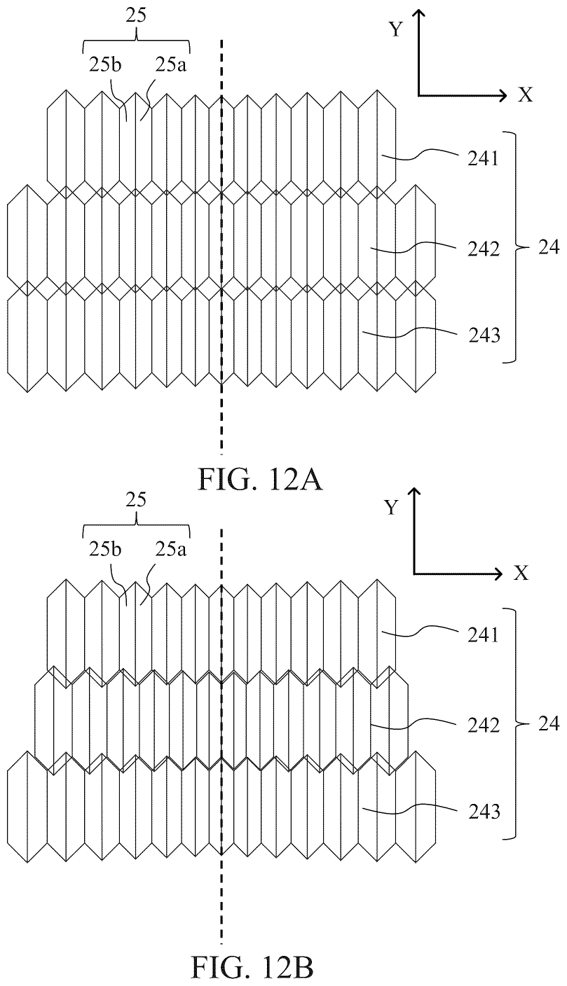

Referring now to FIGS. 12A and 12B, a description will be given of the arrangement of a plurality of retroreflection mirrors (first retroreflection mirror 241, second retroreflection mirror 242, third retroreflection mirror 243) constituting the reconstruction mirror in this embodiment. FIG. 12A illustrates the arrangement of multiple retroreflection mirrors in this embodiment. As illustrated in FIG. 12A, the plurality of retroreflection mirrors are arranged so that they have the same phase in the vertical direction (the top peaks and bottom peaks of the right-angle mirrors constituting the retroreflection mirrors 241, 242, and 243 are aligned). However, this embodiment is not limited to this example, and for example, a configuration as illustrated in FIG. 12B may be adopted.

FIG. 12B illustrates the arrangement of a plurality of retroreflection mirrors 241, 242, and 243 according to a variation of this embodiment. As illustrated in FIG. 12B, in this variation, the second retroreflection mirror 242 is disposed so that it has a different phase in the vertical direction from that of the first retroreflection mirror 241 and the third retroreflection mirror 243. This variation can provide a higher quality image by reducing the gap formed between the first retroreflection mirror 241 or the third retroreflection mirror 243 and the second retroreflection mirror 242 and reducing artifacts.

This embodiment can provide a thin observation optical system with high light utilization efficiency. The conditions or variations described in this embodiment are also applicable to the second embodiment described below.

### Second Embodiment

A second embodiment of the present disclosure will be described. In the first embodiment, a light guide plate (one-dimensional pupil reconstruction light guide plate) 20 forms a second pupil at the eyepoint 31 by reconstructing the exit pupil of the projection optical system 12 only in a one-dimensional direction (for example, the horizontal direction). In this embodiment, a light guide plate (two-dimensional pupil reconstruction light guide plate) forms a second pupil at the eyepoint 31 by reconstructing the exit pupil of the projection optical system 12 in two-dimensional directions (for example, both the horizontal and vertical directions).

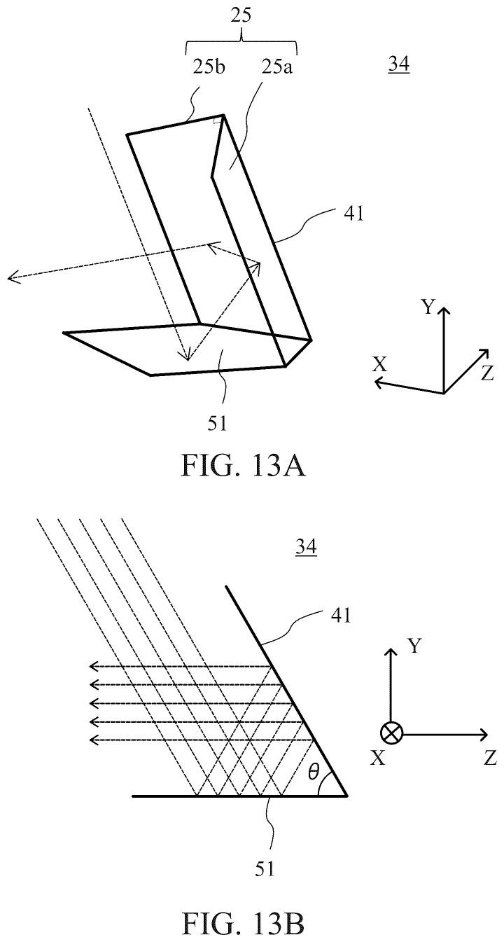

Referring now to FIGS. 13A and 13B, a description will be given of the two-dimensional pupil reconstruction mirror unit 34 in this embodiment. FIGS. 13A and 13B explain the pupil reconstruction mirror unit 34 in this embodiment. The light guide plate in this embodiment has a plurality of two-dimensional pupil reconstruction mirror units 34, i.e., two-dimensional pupil reconstruction mirrors, which are arranged two-dimensionally along the horizontal direction (X-axis direction) and vertical direction (Y-axis direction). As illustrated in FIG. 13A, one pupil reconstruction mirror unit 34 constituting the two-dimensional pupil reconstruction mirror has the right-angle mirror 25 consisting of the first mirror 25a and the second mirror 25b that are orthogonal to each other, and a plane mirror (third mirror) 51. The plane mirror 51 is, for example, a half-mirror.

As illustrated in FIG. 13B, the plane mirror 51 is disposed so as to form an angle θ (degrees) with a ridgeline (edge line) 41 of the right-angle mirror 25. The angle θ (degrees) may satisfy the following inequality (3) in order to reduce the gap between the light beams from a direction that includes a vertical component, for example.

$$40 < θ < 80 \qquad ( 3 )$$

In a case where θ becomes higher than the upper limit or lower than the lower limit of inequality (3), the gap between the light beams from a direction that includes a vertical component, for example, cannot be reduced sufficiently.

Inequality (3) may be replaced with inequality (3a) below:

$$50 < θ < 70 \qquad ( 3 a )$$

Inequality (3) may be replaced with equation (3b) below:

$$θ = 60 \qquad ( 3 b )$$

Thus, this embodiment achieves pupil reconstruction in the horizontal direction using the right-angle mirror 25, and pupil reconstruction in the vertical direction using the right-angle mirror 25 and the plane mirror 51 disposed to form the angle θ with the ridgeline 41 of the right-angle mirror 25. Thereby, the second pupil can be reconstructed in two directions, the horizontal direction and the vertical direction.

More specifically, in the horizontal direction, this embodiment reconstructs the second pupil using the retroreflection function of the right-angle mirror array by reflecting each angle-of-view light beam emitted from the exit pupil of the projection optical system using the right-angle mirror array.

In the vertical direction, this embodiment will discuss the plane mirror 51 set to θ=60° for the ridgeline 41 of the right-angle mirror 25. The two-dimensional pupil reconstruction mirror is disposed so that the ridgeline 41 of the right-angle mirror 25 is parallel to the incident light. The incident light is first reflected by the plane mirror 51, and then reflected by the two surfaces of the right-angle mirror 25, where the reflected light is reflected in a direction approximately parallel to the plane mirror 51.

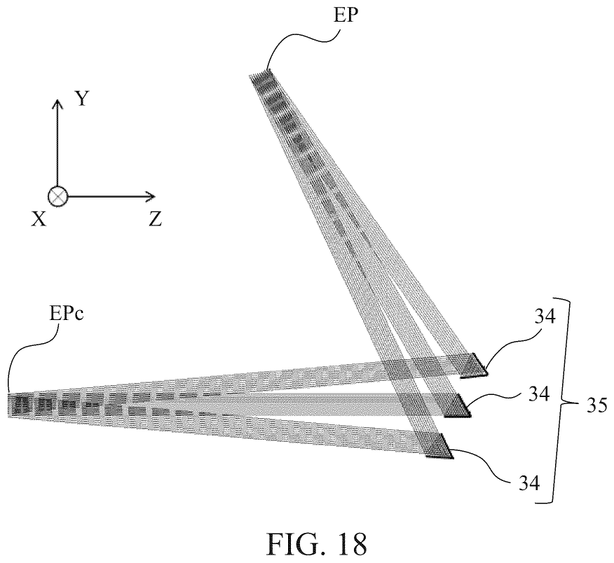

FIG. 18 illustrates the pupil reconstruction in the pupil reconstruction mirror unit 34 in a vertical section. In a case where angle-of-view light beams emitted and diffused from the first pupil EP of the projection optical system are reflected by the different pupil reconstruction mirror units 34, a distance between the reflected angle-of-view light beams narrows as they travel, and the angle-of-view light beams are condensed at approximately the same position and overlap each other to form the second pupil EPc. Thus, even in the vertical direction, the two-dimensional pupil reconstruction mirror can form a second pupil reconstructed from the first pupil of the projection optical system. Since the plane mirror 51 is set to have an angle θ relative to the ridgeline 41 of the right-angle mirror 25, as described above, the second pupil can be reconstructed in a different location from the first pupil in the vertical section.

This embodiment can reconstruct a second pupil from the first pupil (exit pupil) of the projection optical system can be formed in two-dimensional directions in the horizontal and vertical sections. In a case where the second pupil is formed at the position of the eyepoint, the light from the display element can be efficiently guided to the observer's eye. Thereby, the light utilization efficiency can be further improved.

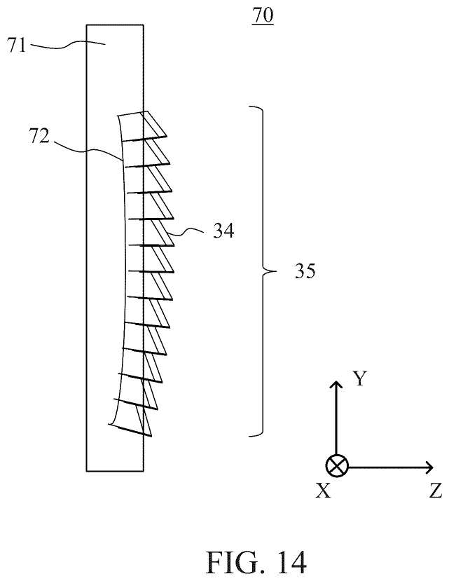

FIG. 14 is a sectional view (YZ section) of a light guide plate (light guide element) 70 having a two-dimensional pupil reconstruction mirror 35 in this embodiment. The light guide plate 70 has the two-dimensional pupil reconstruction mirror 35 that includes a plurality of pupil reconstruction mirror units 34 arranged along the horizontal and vertical directions on a light guide substrate 71. In this embodiment, the two-dimensional pupil reconstruction mirror 35 includes a first pupil reconstruction mirror that includes a plurality of pupil reconstruction mirror units 34 arranged in a row along the horizontal direction, and the first pupil reconstruction mirrors are arranged in a row along the vertical direction.

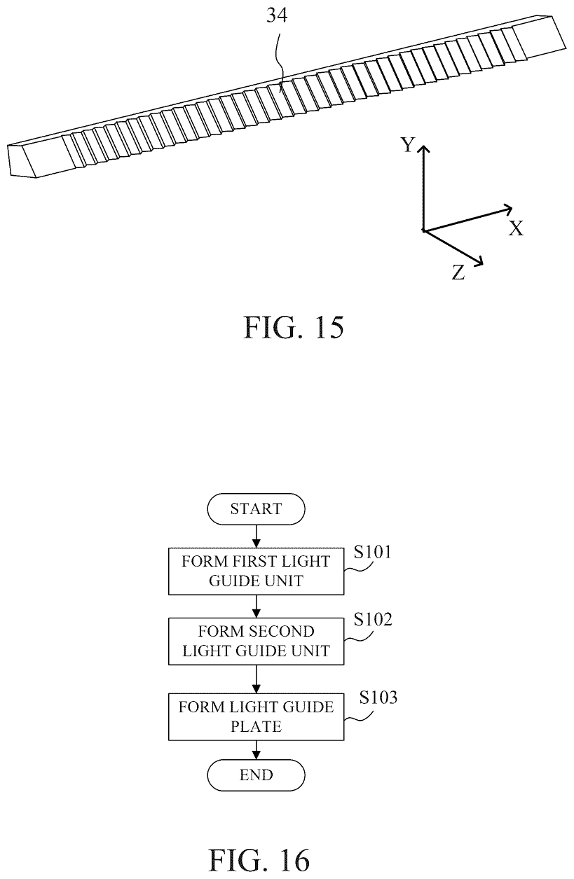

FIG. 15 is a perspective view of the first pupil reconstruction mirror. As illustrated in FIG. 15, the first pupil reconstruction mirror has 39 pupil reconstruction mirror units 34 arranged along the horizontal direction (X-axis direction). However, the number of pupil reconstruction mirror units 34 is not limited to this example. As illustrated in FIG. 14, the two-dimensional pupil reconstruction mirror 35 is configured by arranging 12 first pupil reconstruction mirrors along the vertical direction (Y-axis direction) on a cylindrical surface 72 formed on a light guide substrate 71. However, the number of first pupil reconstruction mirrors is not limited to this example. The pupil reconstruction mirror unit 34 on the cylindrical surface 72 is configured so that the rotation angle increases (rotates inward) as the position approaches the peripheral portion from the central portion in the vertical direction as well. The pupil reconstruction mirror unit 34 may be disposed by rotating it inward even partially, without being limited to the arrangement on the cylindrical surface 72. This configuration can form the second pupil while reducing a gap between the light beams reflected by the two-dimensional pupil reconstruction mirror 35 in two directions, the horizontal direction and the vertical direction.

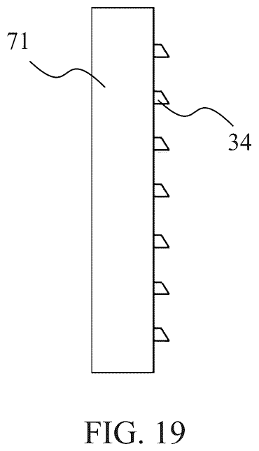

As a variation of the second embodiment, FIG. 19 illustrates a light guide substrate 71 using a two-dimensional pupil reconstruction mirror that enables Maxwellian vision.

The size of each pupil reconstruction mirror unit 34 is set to 2 mm or less, and adjacent pupil reconstruction mirror units 34 are spaced apart and arranged sparsely in a third section including the X-axis and Y-axis of the light guide substrate 71. Thereby, a light guide plate using a two-dimensional pupil reconstruction mirror that enables Maxwellian vision can be configured by setting the light beam reflected by each pupil reconstruction mirror unit to 1 mm or less.

### Third Embodiment

Referring to FIGS. 16, 17A, and 17B, a description will be given of a manufacturing method of the observation optical system (light guide plate 20) in this embodiment. FIG. 16 is a flowchart illustrating a manufacturing method of the light guide plate 20. FIGS. 17A and 17B explain the components that constitute the light guide plate 20. FIG. 17A illustrates a first light guide unit 201, and FIG. 17B illustrates a second light guide unit 202. This embodiment will describe a manufacturing method of the light guide plate 20 described in the first embodiment, but is also applicable to other light guide plates such as the light guide plate 70 described in the second embodiment.

First, in step S101, the first light guide unit 201 having the light guide substrate 21, the head (incident section) 22, and the pupil reconstruction mirror 24 is formed (first forming step). At this time, a reflective film or half-mirror film is formed on the reflective surface 27 of the pupil reconstruction mirror 24. In a case where the first light guide unit 201 has a plurality of pupil reconstruction mirrors 24, the characteristics of the reflective film or half-mirror film are made different for each pupil reconstruction mirror 24 in order to adjust the brightness according to the angle of view of the displayed image (so that the brightness of the displayed image viewed by the observer is constant). Here, the characteristics of the reflective film or half-mirror film include, for example, a transmittance characteristic and a reflectance characteristic. That is, the reflectance of the film formed on the lower pupil reconstruction mirror 24 is made high and the transmittance is made low. For example, the reflectance of the film formed on the third retroreflection mirror 243 is higher than the reflectance of the film formed on the first retroreflection mirror 241, and the transmittance of the film formed on the third retroreflection mirror 243 is lower than the transmittance of the film formed on the first retroreflection mirror 241. This embodiment is not limited to this example, and a half-mirror with the same characteristics may be used.

The head (entrance portion) 22 may be integrally formed with the light guide substrate 21, or may be separately formed and then joined to the light guide substrate 21. In forming it by injection molding, the former can achieve positional accuracy between the light guide substrate 21 and the head 22, while the latter has the advantage of improving surface accuracy during molding because a thickness difference within the molded part reduces.

Next, in step S102, a second light guide unit 202 is formed, which has a pupil reconstruction mirror interpolation unit 84 of a similar shape to that of the pupil reconstruction mirror 24 (second forming step).

Next, in step S103, the first light guide unit formed in step S101 and the second light guide unit formed in step S102 are adhered together using an adhesive to form the light guide plate 20 (third forming step). At this time, the pupil reconstruction mirror 24 and the pupil reconstruction mirror interpolation unit 84 are adhered together to form the light guide plate 20. An adhesive having a refractive index similar to that of the molded product can reduce the visibility of the adhered surface. Thus, the pupil reconstruction mirror 24 as an internal structure of the light guide plate 20 is hard to recognize, and the transparency of the adhered molded product can be improved.

Thus, the light guide plate 20 is divided into two molded products (first light guide unit 201 and second light guide unit 202) with respect to the reflective surface or half-mirror surface as the boundary. Then, a reflective film or half-mirror film is evaporated onto one molded product (first light guide unit 201), and the other molded product (second light guide unit 202) is shaped similar to the shape of the reflective surface or half-mirror surface. A gap of 0.05 mm is provided between them, and a positioning protrusion 85 comes into contact with the positioning surface 281 when they are joined.

Thereby, one molded product can be positioned with high accuracy relative to the other molded product. More specifically, the tilt of a light guide plane 86 on the opposite side to the eyepoint of the second light guide unit 202 is set to be parallel to the flat substrate 291 on the opposite side to the eyepoint (plane substrate 292) of the light guide substrate 21 of the first light guide unit 201 with an accuracy of less than one arc minute.

A reflective surface or a half-mirror surface may be provided on the molded product (first light guide unit 201) that is closer to the eyepoint 31 among the divided molded products. In the light guide plate 20, a light beam reflected by the plane substrate 292 on the side closer to the eyepoint 31 is reflected by the pupil reconstruction mirror 24 and guided to the eyepoint 31. Thus, the joint surface of the reflective film or half-mirror film becomes the molded product. The joint surface becomes a surface on which the molded product is directly vapor-deposited, and a good reflection characteristic can be easily obtained.

The molded product provided with the reflective surface or half-mirror surface may be the same molded product as the light guide substrate 21. This is because the light guide substrate 21 is thicker than the pupil reconstruction mirror section, and it is easier to stabilize the surface accuracy and tilt accuracy by providing the reflective surface 27 of the pupil reconstruction mirror 24 in the first light guide unit 201 where the light guide substrate 21 is present. The pupil reconstruction mirror interpolation unit 84, which does not require surface accuracy, may be provided to the second light guide unit 202, which tends to be thin.

This embodiment manufactures the light guide plate 20 by bonding two molded products (the first light guide unit 201 and the second light guide unit 202), and thus can achieve mass productivity and maintain optical performance of the light guide plate 20.

One variation of this embodiment may manufacture the light guide plate 20 using the following steps.

In step S101, the first light guide unit 201 is formed, which has the light guide substrate 21, the head (entrance section) 22, the pupil reconstruction mirror 24 and the pupil reconstruction mirror interpolation unit 84 having a similar shape (first forming step).

Next, in step S102, the second light guide unit 202 having the pupil reconstruction mirror 24 is formed (second forming step).

Next, in step S103, the first light guide unit formed in step S101 and the second light guide unit formed in step S102 are adhered together using an adhesive to form the light guide plate 20 (third forming step).

This variation performs deposition on the pupil reconstruction mirror 24 of the second light guide unit 202. In this case, since the second light guide unit 202 is smaller than the first light guide unit 201, many second light guide units 202 can be installed in a deposition furnace, and the number of formable films in a single deposition process can be increased. Thereby, the cost reduction can be acquired.

The optical system according to each embodiment includes a light guide plate (pupil reconstruction light guide plate) that forms a second pupil at the position of the observer's eye by reconstructing the first pupil of the projection section at the position of the observer's eye, and thus can reduce the weight of the battery and maintain brightness that can be used in bright environments such as outdoors.

The configurations disclosed in the prior art references use a light guide plate, which can achieve a thin observation optical system, but the light utilization efficiency of the light guide plate (the proportion of light projected by the projection unit that reaches the observer's eye) is low. As a result, it is difficult to achieve brightness (luminance) that can be used in bright environments such as outdoors, and to reduce the weight of the battery. On the other hand, each embodiment can provide an optical system that has a reduced thickness and high light utilization efficiency (the proportion of light projected by the projection unit that reaches the observer's eye).

While the disclosure has described example embodiments, it is to be understood that the disclosure is not limited to the example embodiments. The scope of the following claims is to be accorded the broadest interpretation so as to encompass all such modifications and equivalent structures and functions.

What is claimed is:

1. An optical system configured to guide light from a display element to an eyepoint, the optical system comprising:
a projection unit configured to project the light from the display element; and
a light guide configured to guide the light from the projection unit to the eyepoint,
wherein the eyepoint is located outside the light guide,
wherein the projection unit forms a first pupil,
wherein the light guide has a reflector configured to form a second pupil at the eyepoint in a first section, and
wherein the following inequality is satisfied:
$$0 \leq A 1 / f < 0.5$$
where fl is a focal length of the reflector in the first section of the reflector, and A1 is an air-equivalent distance on an optical axis from a reflective surface of the reflector to the first pupil.

2. The optical system according to claim 1, wherein the following inequality is satisfied:
$$0.5 < A 2 / A 1 < 2.0$$
where A2 (mm) is an air-equivalent distance on the optical axis from the reflective surface to the eyepoint.

3. The optical system according to claim 1, wherein the light guide includes a substrate that holds the reflector,
wherein the reflective surface is tilted relative to a surface of the substrate in a second section orthogonal to the first section, and
wherein light reflected by the reflector passes through the substrate and is emitted to outside of the light guide.

4. The optical system according to claim 3, wherein the reflector includes a plurality of reflective surfaces arranged in a second direction orthogonal to the first section, and angles formed between the plurality of reflective surfaces and the surface of the substrate are equal to each other.

5. The optical system according to claim 1, wherein the reflector includes a plurality of right-angle mirrors, each of which has two reflective surfaces that form a right angle with each other in the first section, and the plurality of right-angle mirrors are arranged along a first direction parallel to the first section.

6. The optical system according to claim 5, wherein distances from bottom peaks to top peaks of the plurality of right-angle mirrors are equal to each other.

7. The optical system according to claim 5, wherein in the first section, distances from bottom peaks to top peaks of the plurality of right-angle mirrors increase from a central portion to a peripheral portion of the reflector.

8. The optical system according to claim 5, wherein a first mirror that includes an inner reflective surface of each of the plurality of right-angle mirrors is wider than a second mirror that includes an outer reflective surface of each of the plurality of right-angle mirrors.

9. The optical system according to claim 8, wherein at least one of second mirrors of the plurality of right-angle mirrors has a cut surface cut at an angle different from that of a mirror surface.

10. The optical system according to claim 5, wherein in the first section, rotation angles for angles of the plurality of right-angle mirrors increase from a central portion to a peripheral portion.

11. The optical system according to claim 5, further comprising a light shielding member disposed between adjacent right-angle mirrors among the plurality of right-angle mirrors.

12. An optical system configured to guide light from a display element to an eyepoint, the optical system comprising:
a projection unit configured to project the light from the display element; and
a light guide configured to guide the light from the projection unit to the eyepoint,
wherein the eyepoint is located outside the light guide,
wherein the projection unit forms a first pupil, and
wherein the light guide has a reflector configured to form a second pupil at the eyepoint in a first section and a second section orthogonal to the first section.

13. The optical system according to claim 12, wherein that the reflector includes:
a right-angle mirror array in which a plurality of right-angle mirrors are arranged along a first direction parallel to the first section, each right-angle mirror including a first mirror and a second mirror forming a right angle in the first direction, and
a third mirror as a plane mirror, and
wherein the following inequality is satisfied:
$$40 < θ < 80$$
where θ (degrees) is an angle formed by a ridgeline between the first mirror and the second mirror, and the third mirror.

14. The optical system according to claim 13, wherein the third mirror is a half-mirror.

15. The optical system according to claim 12, wherein a plurality of two-dimensional pupil reconstruction mirrors, each of which includes a right-angle mirror array and a third mirror are arranged in a second direction.

16. The optical system according to claim 15, wherein the two-dimensional pupil reconstruction mirrors arranged in the second direction have tilt angles different from each other in the second section.

17. An optical system configured to guide light from a display element to an eyepoint, the optical system comprising:
a projection unit configured to project the light from the display element; and
a light guide configured to guide the light from the projection unit to the eyepoint,
wherein the eyepoint is located outside the light guide,
wherein the light guide includes a first reflector configured to deflect the light from the projection unit, two inner surfaces that face each other, and a second reflector that emits the light reflected by the first reflector and the two inner surfaces to outside of the light guide,
wherein the first reflector includes a first reflective surface orthogonal to the two inner surfaces,
wherein the second reflector includes a plurality of reflective surfaces that are arranged in a direction parallel to the two inner surfaces, and
wherein the first reflective surface is tilted relative to the direction parallel to the two inner surfaces in a section parallel to the two inner surfaces.

18. The optical system according to claim 17, wherein in the section parallel to the two inner surfaces, an angle formed by an optical path from the projection unit to the first reflector and an optical path from the first reflector to the second reflector is an acute angle.
